(19) United States
(12) Patent Application Publication
(10) Pub. No.: US 2025/0238713 A1
(43) Pub. Date: Jul. 24, 2025

(54) CONTROL GROUP IDENTIFICATION AND VALIDATION

(71) Applicant: Capital One Services, LLC, McLean, VA (US)

(72) Inventors: Michael SCHWEIZER, Santa Barbara, CA (US); Theodore LIAO, Kirkland, WA (US); Shawn AHN, Annandale, VA (US)

(21) Appl. No.: 18/421,321

(22) Filed: Jan. 24, 2024

(51) Int. Cl. G06N 20/00

(52) U.S. Cl. CPC G06N 20/00

(57) ABSTRACT

In some implementations, a simulator device may receive first target variable information, associated with a test group, and second target variable information, associated with a plurality of possible control groups. The simulator device may determine a first control group and a second control group, from random selections from the possible control groups, based on applying a nearest neighbor algorithm to the first and second target variable information. The simulator device may determine a target variable change based on the first target variable information and a portion of the second target variable information associated with the first control group and the second control group. The simulator device may validate the target variable change based on a portion of the second target variable information associated with the first control group and the second control group. The simulator device may output the target variable change in response to validating the target variable change.

### BACKGROUND

In order to try and detect a causal correlation in a non-experimental setting, computer simulations may be used. For example, different cohorts may be selected and compared over time in order to try and identify a causal correlation.

### SUMMARY

Some implementations described herein relate to a system for identifying and validating control groups. The system may include one or more memories and one or more processors communicatively coupled to the one or more memories. The one or more processors may be configured to identify a plurality of possible control groups that are similar to a test group. The one or more processors may be configured to receive, from a data source, first target variable information, associated with the test group, associated with at least a first time and a second time subsequent to the first time. The one or more processors may be configured to receive, from the data source, second target variable information, associated with the plurality of possible control groups, associated with at least the first time and the second time. The one or more processors may be configured to assemble a first control group, from a first random selection from the plurality of possible control groups, based on applying a nearest neighbor algorithm to the first and second target variable information associated with the first time. The one or more processors may be configured to assemble a second control group, from a second random selection from the plurality of possible control groups, based on applying the nearest neighbor algorithm to the first and second target variable information associated with the first time. The one or more processors may be configured to determine a target variable change by comparing the first target variable information, associated with the test group and with the second time, against a portion of the second target variable information, associated with the first control group and the second control group and with the second time. The one or more processors may be configured to perform a first validation of the target variable change by comparing a distribution of the first target variable information, associated with the test group and with the first time, against a distribution of a portion of the second target variable information, associated with the first control group and the second control group and with the first time. The one or more processors may be configured to perform a second validation of the target variable change by comparing a portion of the second target variable information, associated with the first control group and with the second time, against a portion of the second target variable information, associated with the second control group and with the second time. The one or more processors may be configured to output the target variable change in response to the first validation and the second validation.

Some implementations described herein relate to a method of identifying and validating control groups. The method may include receiving, from a data source, first target variable information, associated with a test group, associated with at least a first time and a second time subsequent to the first time. The method may include receiving, from the data source, second target variable information, associated with a plurality of possible control groups, associated with at least the first time and the second time. The method may include determining, by a simulator device, a first control group, from a first random selection from the plurality of possible control groups, based on applying a nearest neighbor algorithm to the first and second target variable information associated with the first time. The method may include determining, by the simulator device, a second control group, from a second random selection from the plurality of possible control groups, based on applying the nearest neighbor algorithm to the first and second target variable information associated with the first time. The method may include determining, by the simulator device, a target variable change based on the first target variable information, associated with the test group and with the second time, and a portion of the second target variable information, associated with the first control group and the second control group and with the second time. The method may include validating, by the simulator device, the target variable change based on a portion of the second target variable information, associated with the first control group and with the second time, and a portion of the second target variable information, associated with the second control group and with the second time. The method may include outputting, to a user device, the target variable change in response to validating the target variable change.

Some implementations described herein relate to a non-transitory computer-readable medium that stores a set of instructions for identifying and validating control groups. The set of instructions, when executed by one or more processors of a device, may cause the device to receive, from a data source, first target variable information, associated with a test group, associated with at least a first time and a second time subsequent to the first time. The set of instructions, when executed by one or more processors of the device, may cause the device to receive, from the data source, second target variable information, associated with a plurality of possible control groups, associated with at least the first time and the second time. The set of instructions, when executed by one or more processors of the device, may cause the device to identify a first control group, from a first random selection from the plurality of possible control groups, based on applying a nearest neighbor algorithm to the first and second target variable information associated with the first time. The set of instructions, when executed by one or more processors of the device, may cause the device to identify a second control group, from a second random selection from the plurality of possible control groups, based on applying the nearest neighbor algorithm to the first and second target variable information associated with the first time. The set of instructions, when executed by one or more processors of the device, may cause the device to determine a target variable change using the first target variable information, associated with the test group and with the second time, and a portion of the second target variable information, associated with the first control group and the second control group and with the second time. The set of instructions, when executed by one or more processors of the device, may cause the device to perform a validation of the target variable change using a distribution of the first target variable information, associated with the test group and with the first time, and a distribution of a portion of the second target variable information, associated with the first control group and the second control group and with the first time. The set of instructions, when executed by one or more processors of the device, may cause the device to output the target variable change in response to the validation.

### BRIEF DESCRIPTION OF THE DRAWINGS

FIGS. 1A-1C are diagrams of an example implementation relating to control group identification and validation, in accordance with some embodiments of the present disclosure.

FIGS. 2A-2B are diagrams of an example implementation relating to control group identification, in accordance with some embodiments of the present disclosure.

FIG. 3 is a diagram of an example implementation relating to a target variable change, in accordance with some embodiments of the present disclosure.

FIGS. 4A-4B are diagrams of example implementations relating to control group validation, in accordance with some embodiments of the present disclosure.

FIG. 5 is a diagram of an example environment in which systems and/or methods described herein may be implemented, in accordance with some embodiments of the present disclosure.

FIG. 6 is a diagram of example components of one or more devices of FIG. 5, in accordance with some embodiments of the present disclosure.

FIG. 7 is a flowchart of an example process relating to control group identification and validation, in accordance with some embodiments of the present disclosure.

### DETAILED DESCRIPTION

The following detailed description of example implementations refers to the accompanying drawings. The same reference numbers in different drawings may identify the same or similar elements.

In order to determine a possible causal correlation in a non-experimental setting, a computer simulation may calculate a change in a target variable within a test cohort. For example, target variable information before and after a causal event may be compared. However, this technique may incorrectly identify causal correlations. For example, noise or changes that are unrelated to the causal event may result in changes in the target variable. In order to improve accuracy, the test cohort may be compared with a control cohort in order to try to isolate noise and other effects unrelated to the causal event.

Generally, a control cohort may be selected by comparing other variables between the control cohort and the test cohort. However, the control cohort may include noise or changes unrelated to the causal event similar to the test cohort. As a result, an identified change in the target variable may be inaccurate, which wastes power and processing resources that are expended on selecting a new control cohort and re-running the computer simulation.

Some implementations described herein enable bootstrapping a control group, for a test group, using random selection and a nearest neighbor algorithm. As a result, a target variable change determined using the control group and the test group is more likely to be accurate, which conserves power and processing resources that otherwise would have been wasted on selecting a new control group and re-determining the target variable change. Additionally, or alternatively, some implementations described herein enable validation of control groups. For example, control groups may be validated against each other (e.g., by comparing the target variable after a causal event) and/or against the test group (e.g., by comparing target variable distributions before the causal event). As a result, a target variable change determined using the control group and the test group is more likely to be accurate, which conserves power and processing resources, as described above.

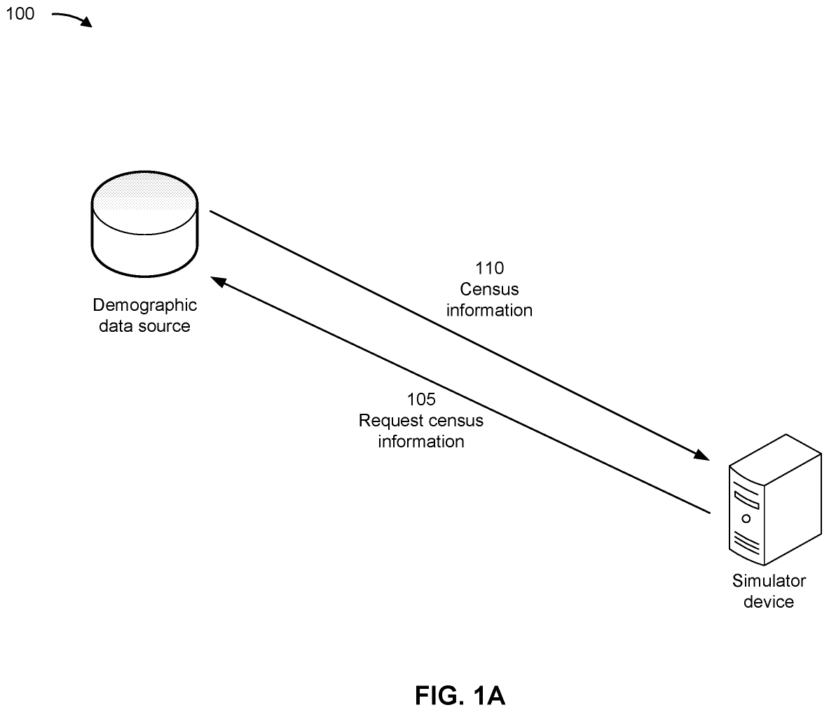

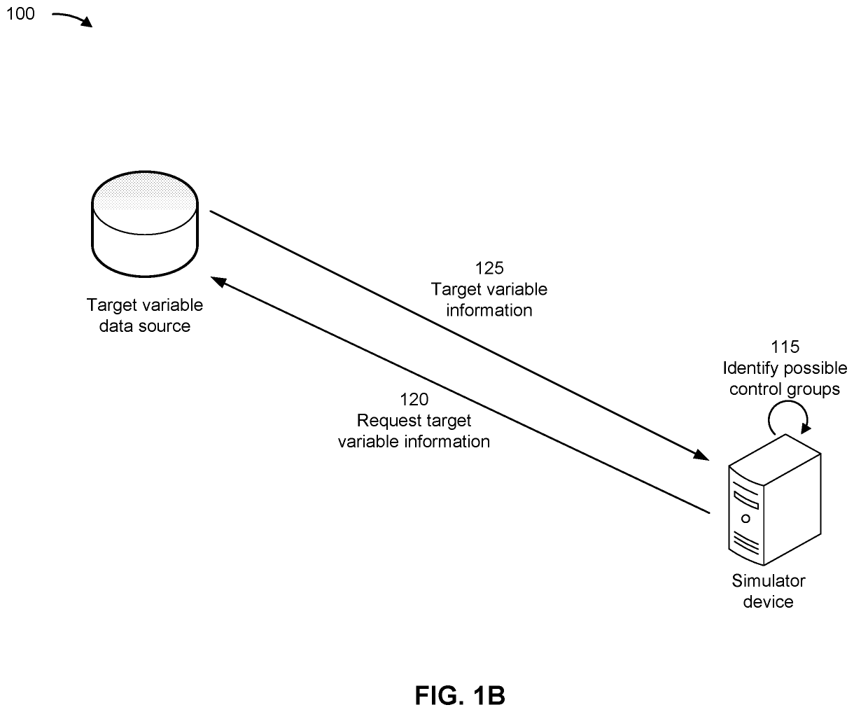

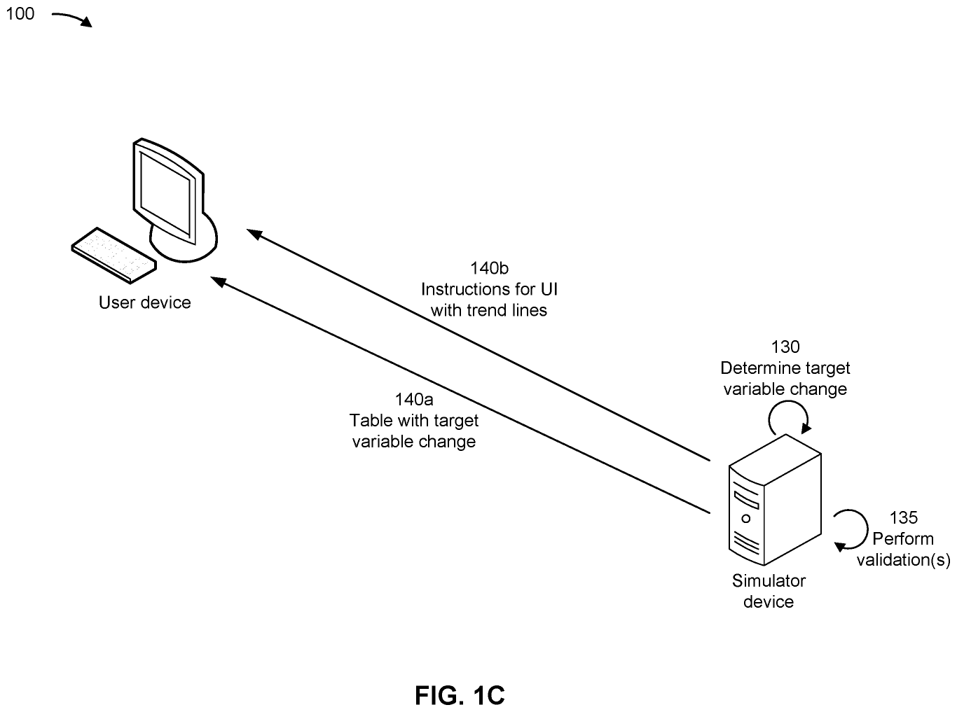

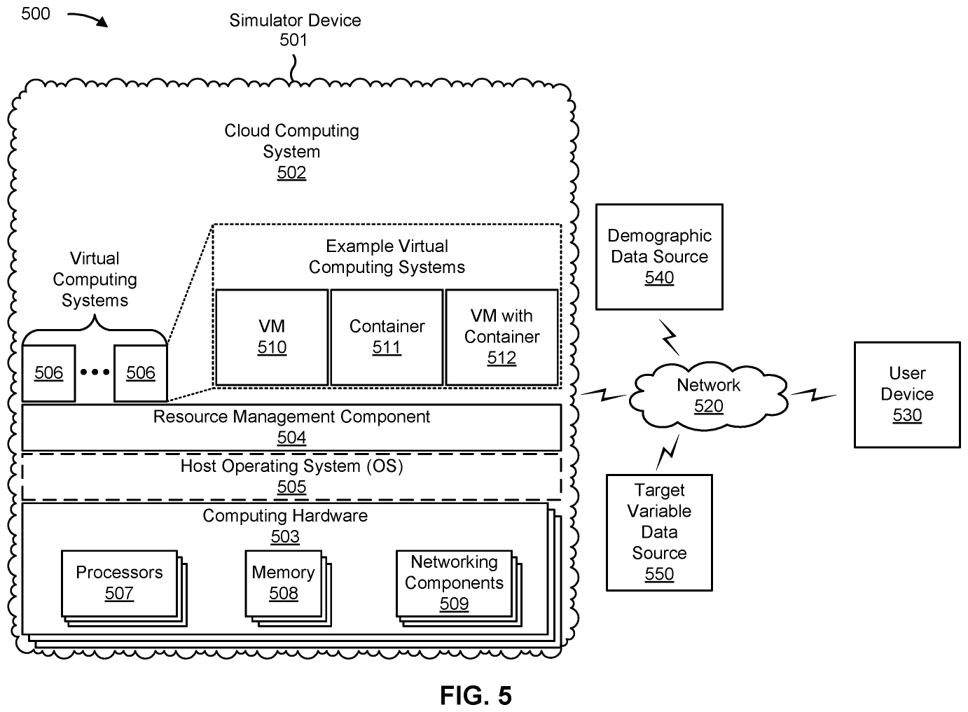

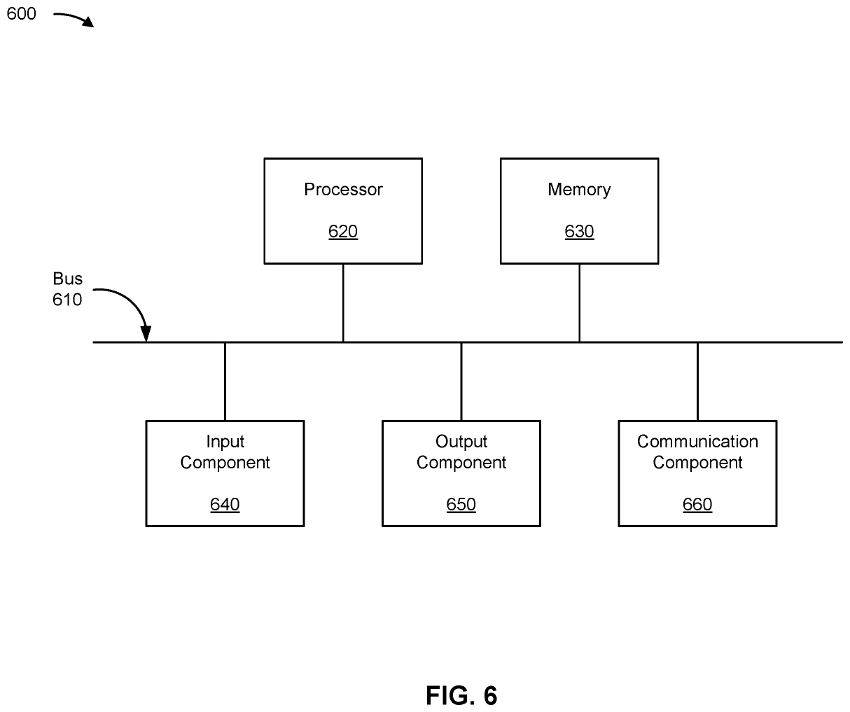

FIGS. 1A-1C are diagrams of an example 100 associated with control group identification and validation. As shown in FIGS. 1A-1C, example 100 includes a simulator device, data sources, and a user device. These devices are described in more detail in connection with FIGS. 5 and 6.

As shown in FIG. 1A and by reference number 105, the simulator device may transmit, and a demographic data source may receive, a request for census information. For example, the request may include a hypertext transfer protocol (HTTP) request and/or an application programming interface (API) call, among other examples. The request may include (e.g., in a header and/or as an argument) an indication of groups for which the simulator device is requesting census information. For example, the simulator device may indicate geographic areas (e.g., census block groups) for which the simulator device is requesting the census information. The geographic areas may be selected by a user of the user device (and indicated to the simulator device) and/or may be selected randomly (or pseudo-randomly) by the simulator device, among other examples. The simulator device may transmit the request according to a schedule (e.g., once per hour or once per day, among other examples) and/or in response to a command to transmit the request. For example, the user device may transmit, and the simulator device may receive, the command, such that the simulator device transmits the request in response to the command.

As shown by reference number 110, the demographic data source may transmit, and the simulator device may receive, the census information. The demographic data source may transmit the census information in response to the request from the simulator device. The census information may be included in an HTTP response and/or a return from an API call (e.g., as described above).

As shown in FIG. 1B and by reference number 115, the simulator device may identify a plurality of possible control groups that are similar to a test group. The simulator device may identify the plurality of possible control groups using the census information. For example, the simulator device may compare first census information, associated with the test group, with second census information, associated with the plurality of possible control groups. Accordingly, the simulator device may identify the plurality of possible control groups by determining that a difference, between the first census information associated with the test group and the second census information associated with the plurality of possible control groups, satisfies a similarity threshold.

In one example, the user device may indicate the test group to the simulator device (e.g., by indicating a geographic area and/or a census block group associated with the test group), and the simulator device may select the plurality of possible control groups that are similar in area, similar in population, similar in median (or average) age, similar in median (or average) income and/or wealth, and/or similar in median (or average) commute time, among other examples. In another example, the simulator device may select the test group based on a causal event (e.g., selecting a geographic area and/or a census block group associated with a new Capital One® Café or Capital One Lounge that opened in the past year, two years, and so on) and may select the plurality of possible control groups using similarities described above as well as absence of the causal event (e.g., no Capital One® Café or Capital One Lounge within a distance that satisfies a driving threshold). Therefore, the test group may be associated with one geographic area (and/or census block group), and the plurality of possible control groups may be associated with additional geographic areas (and/or census block groups).

Although the example 100 is described in connection with census information, other demographic information may be used in addition to, or in lieu of, census information. For example, the simulator device may receive demographic information from the Central Intelligence Agency's World Factbook and/or from Statista® (among other examples) in addition to, or in lieu of, receiving census information from the U.S. Census Bureau (and/or another state's comparable agency).

Although the example 100 is described in connection with the simulator device identifying the plurality of possible control groups, other examples may include the simulator device receiving an indication of the plurality of possible control groups (as well as an indication of the test group, as described above). For example, the user device may transmit the indication of the plurality of possible control groups (in a same message as includes, or a different message than including, the indication of the test group).

As shown by reference number 120, the simulator device may transmit, and a target variable data source may receive, a request for target variable information. For example, the request may include an HTTP request and/or an API call, among other examples. The request may include (e.g., in a header and/or as an argument) an indication of the test group and the plurality of possible control groups for which the simulator device is requesting target variable information. For example, the simulator device may indicate geographic areas (e.g., census block groups) for which the simulator device is requesting the target variable information. The geographic areas may be associated with the test group and the plurality of possible control groups, as described above.

As shown by reference number 125, the target variable data source may transmit, and the simulator device may receive, the target variable information. The target variable data source may transmit the target variable information in response to the request from the simulator device. The target variable information may be included in an HTTP response and/or a return from an API call (e.g., as described above). The test group may be associated with first target variable information, and the plurality of possible control groups may be associated with second target variable information. Additionally, the target variable information may span a window of time. For example, the first target variable information may include, at least, a portion associated with a first time and a portion associated with a second time subsequent to the first time. Similarly, the second target variable information may include, at least, a portion associated with the first time and a portion associated with the second time subsequent to the first time. Therefore, the first and second target variable information may be used to compare the test group to the plurality of possible control groups across, at least, the first time and the second time.

In some implementations, the simulator device may perform winsorizing on the second target variable information. For example, the simulator device may replace values, in the second target variable information, that satisfy an outlier threshold. Alternatively, the simulator device may perform trimming (also referred to as truncation) to exclude values, in the second target variable information, that satisfy the outlier threshold. Additionally, or alternatively, the simulator device may perform standardization on the first and second target variable information. For example, the simulator device may rescale the first and second target variable information to have a mean of 0 and/or a standard deviation of 1. Therefore, the simulator device may ensure that target variable information with high nominal values (e.g., income) are not inadvertently given more importance than target variable information with low nominal values (e.g., drive time).

By combining the census information with the target variable information, the simulator device improves accuracy of a target variable change (e.g., determined as described below in connection with reference number 130). For example, the simulator device identifies the plurality of possible control groups by comparison across a different dataset (e.g., the census information) than is used to calculate the target variable change (e.g., the target variable information). Increasing accuracy conserves power and processing resources that otherwise would have been wasted on selecting new possible control groups and re-determining the target variable change.

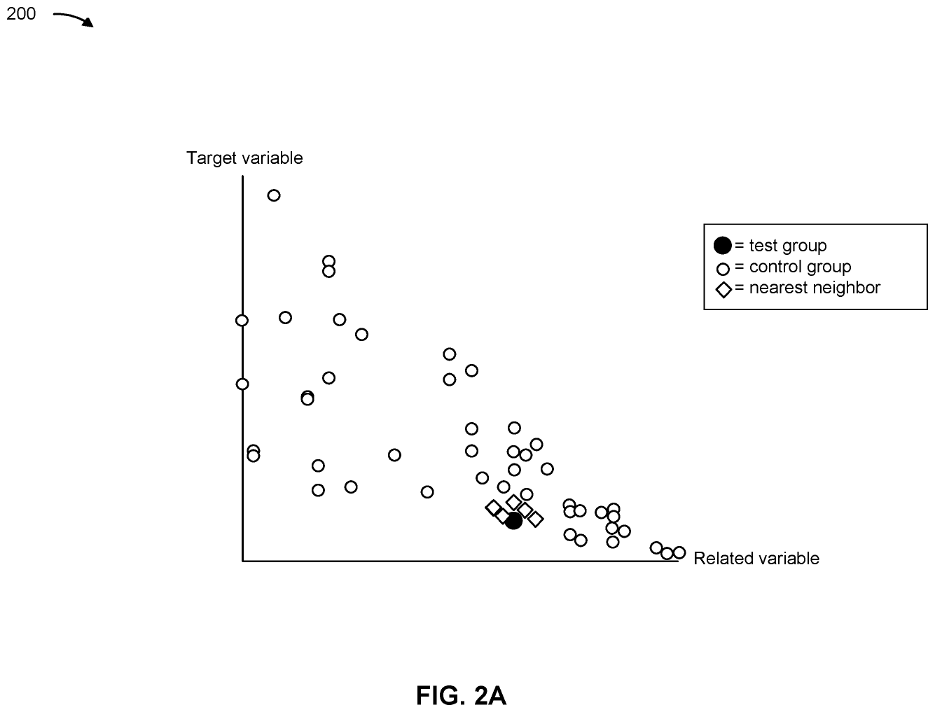

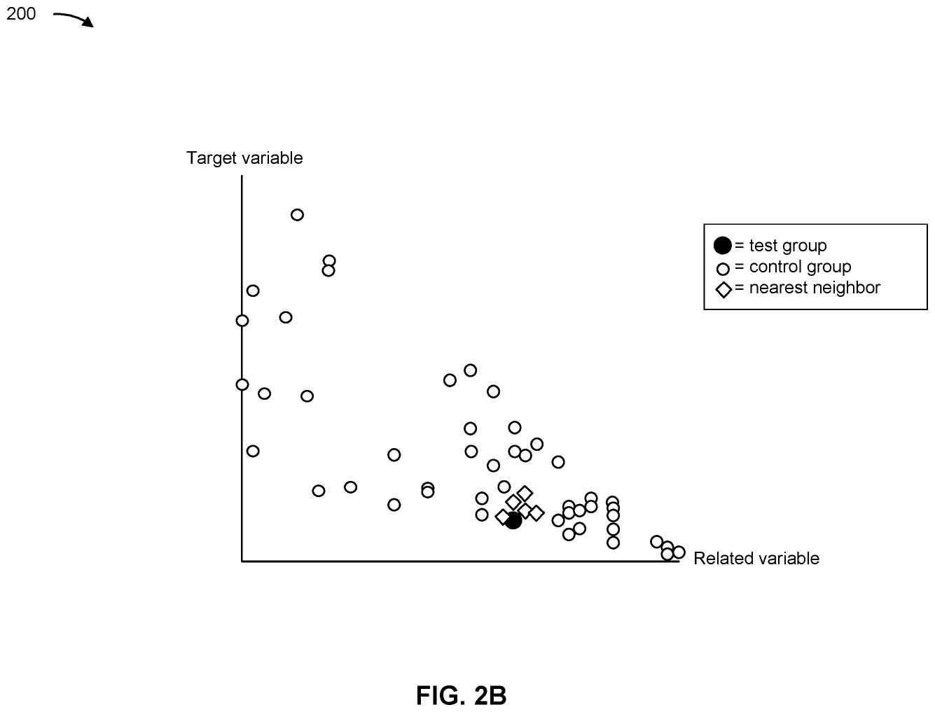

From the plurality of possible control groups, the simulator device may assemble a first control group and a second control group. For example, the simulator device may assemble the first control group, from a first random selection from the plurality of possible control groups, using a nearest neighbor algorithm. The simulator device may apply the nearest neighbor algorithm to the first and second target variable information associated with the first time. An example of the nearest neighbor algorithm, as applied to the first random selection, is described in connection with FIG. 2A. Similarly, the simulator device may assemble the second control group, from a second random selection from the plurality of possible control groups, using the nearest neighbor algorithm. The simulator device may apply the nearest neighbor algorithm to the first and second target variable information associated with the first time. An example of the nearest neighbor algorithm, as applied to the second random selection, is described in connection with FIG. 2B.

As described in connection with FIG. 2A, the simulator device may determine the first control group by performing the first random selection, from the plurality of possible control groups, to generate a first random control sample and by selecting the first control group from the first random control sample using the nearest neighbor algorithm. Similarly, as described in connection with FIG. 2B, the simulator device may determine the second control group by performing the second random selection, from the plurality of possible control groups, to generate a second random control sample and by selecting the second control group from the second random control sample using the nearest neighbor algorithm. Therefore, the simulator device may select, from the plurality of possible control groups, based on similar target variables prior to the causal event.

By using the random selections and the nearest neighbor algorithm, the simulator device bootstraps the first and second control groups. As a result, a target variable change (e.g., determined as described below in connection with reference number 130) is more likely to be accurate, which conserves power and processing resources that otherwise would have been wasted on selecting new possible control groups and re-determining the target variable change.

Although the example 100 is described in connection with two control groups, other examples may include additional control groups. For example, the simulator may use additional rounds of random selection and application of the nearest neighbor algorithm to assemble additional control groups from the plurality of possible control groups.

As shown in FIG. 1C and by reference number 130, the simulator device may determine a target variable change using the first target variable information, associated with the test group, and a portion of the second target variable information, associated with the first control group and the second control group. The simulator device may use the first target variable information and the portion of the second target variable information associated with the second time.

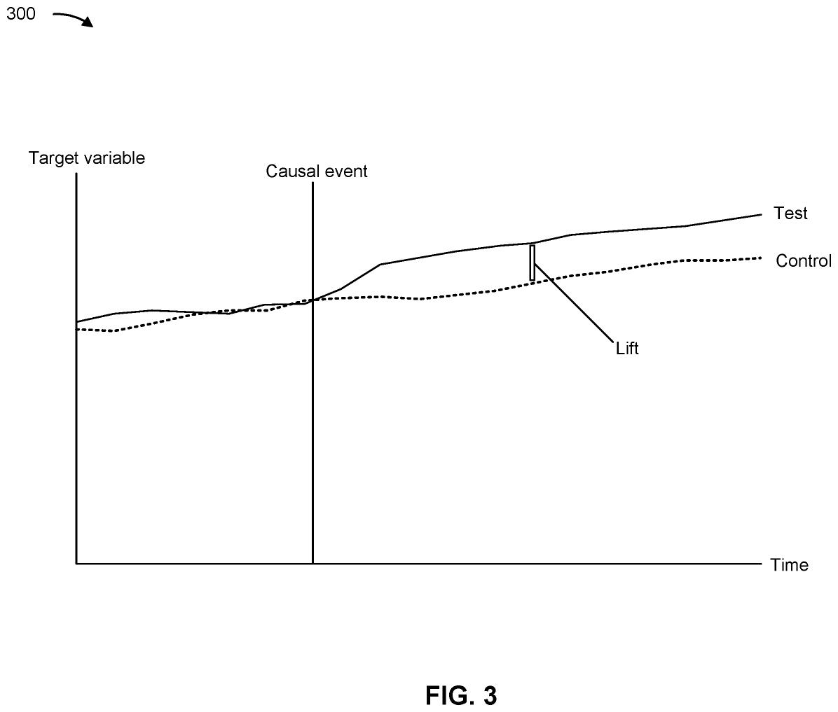

In one example, the simulator device may determine the target variable change by comparing the first target variable information, associated with the test group, against a portion of the second target variable information, associated with the first control group and the second control group. Therefore, the simulator device may determine a difference, in a target variable, between the test group and the first and second control groups after the causal event. The target variable change may be a median (or an average) difference across multiple times after the causal event and/or across the first and second control groups. Additionally, or alternatively, the simulator device may calculate a distance between a first trend line associated with the test group and a second trend line associated with the first control group or the second control group, as described in connection with FIG. 3. Accordingly, the target variable change may be a median (or an average) distance across multiple times (represented on the first and second trend line) and/or across the first and second control groups (e.g., across different second trend lines).

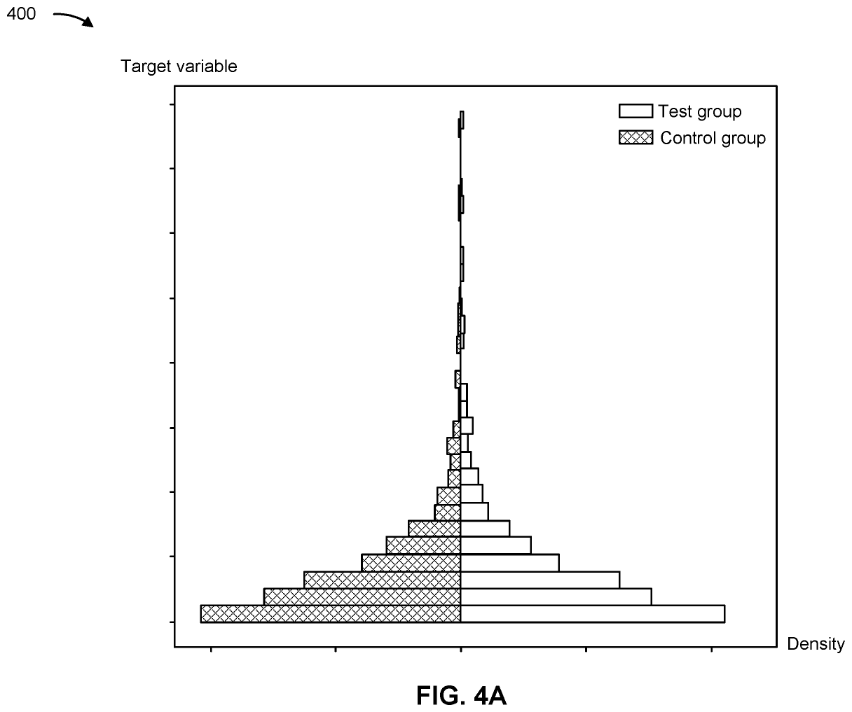

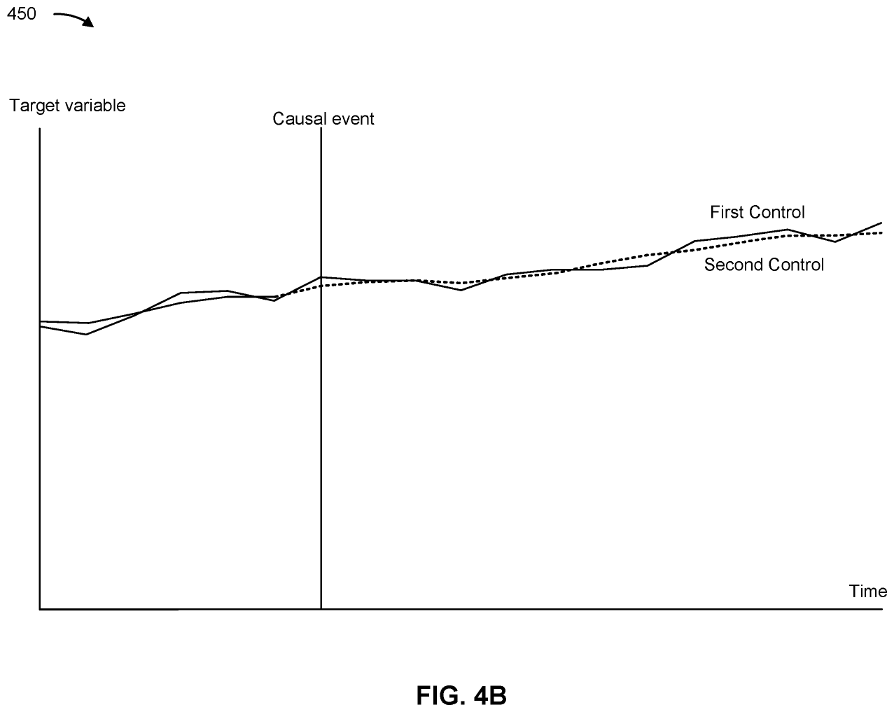

As shown by reference number 135, the simulator device may perform validations (e.g., one or more validations) on the target variable change. In one example, the simulator device may validate the target variable change using a distribution of the first target variable information, associated with the test group, and a distribution of a portion of the second target variable information, associated with the first control group and the second control group. The simulator device may use the first target variable information and the portion of the second target variable information associated with the first time. For example, the simulator device may compare the distribution of the first target variable information, associated with the test group, against the distribution of the portion of the second target variable information, associated with the first control group and the second control group (e.g., as described in connection with FIG. 4A). Therefore, the simulator device may determine a difference measurement, between the distributions, before the causal event and may validate the target variable change based on the difference measurement satisfying a validation threshold. As a result, the simulator device confirms that distributions of the target variable within the control groups are similar to distribution of the target variable within the test group prior to the causal event, which increases confidence that the casual event resulted in the target variable change. Although this validation is described in connection with the target variable, the simulator device may additionally or alternatively perform a validation using distributions associated with a different variable (e.g., using drive time to an airport when the target variable is a number of new credit card bookings).

Additionally, or alternatively, the simulator device may validate the target variable change based on a portion of the second target variable information, associated with the first control group, and a portion of the second target variable information, associated with the second control group. The simulator device may use the portions of the second target variable information associated with second first time. For example, the simulator device may compare the portion of the second target variable information, associated with the first control group, against the portion of the second target variable information, associated with the second control group. Therefore, the simulator device may determine a distance between a first trend line associated with the first control group and a second trend line associated with the second control group (e.g., as described in connection with FIG. 4B) and may validate the target variable change based on the distance satisfying a validation threshold. As a result, the simulator device confirms that the control groups experience similar changes, if any, to the target variable after the causal event, which increases confidence that the casual event resulted in the target variable change (experienced by the test group).

The validations ensure that the target variable change is more accurate. As a result, the simulator device conserves power, processing resources, and network overhead that otherwise would have been wasted on outputting an inaccurate target variable change to the user device.

As shown by reference number 140a, the simulator device may output (e.g., to the user device), the target variable change. The simulator device may transmit, and the user device may receive, the target variable change in response to the validations (described above). In some implementations, the simulator device may output a table including the target variable change. One example table is shown below:

Example Table 1

| Group | Related variable | Target variable change over time |
|---|---|---|
| Control 1 | Option 1 | +0.5% |
| Control 2 | Option 2 | −0.2% |
| Test 1 | Option 1 | +10.2% |
| Test 2 | Option 2 | +6.3% |

The table may be encoded in a file (e.g., a portable document format (pdf) file, a comma-separated values (CSV) file, or a spreadsheet file, among other examples) or may be included in a user interface (UI) (e.g., output via an output component of the user device).

Additionally, or alternatively, shown by reference number 140b, the simulator device may output (e.g., to the user device), instructions to display a UI including the first trend line associated with the test group and the second trend line associated with the first control group or the second control group. For example, the UI may be as shown in FIG. 3. The UI may further indicate the target variable change (e.g., as a distance between the first and second trend lines, as shown in FIG. 3).

By using techniques as described in connection with FIGS. 1A-1C, the simulator device bootstraps the first and second control groups, for a test group, using random selections and the nearest neighbor algorithm. As a result, the target variable change is more likely to be accurate, which conserves power and processing resources that otherwise would have been wasted on selecting new control groups and re-determining the target variable change. Additionally, the simulator device performs validations on the target variable change. As a result, the target variable change is more likely to be accurate, which similarly conserves power and processing resources as described above.

As indicated above, FIGS. 1A-1C are provided as an example. Other examples may differ from what is described with regard to FIGS. 1A-1C.

FIGS. 2A-2B are diagrams of an example 200 associated with control group identification. The example 200 of FIGS. 2A-2B may represent operations performed by a simulator device, which is described in more detail in connection with FIGS. 5 and 6.

As shown in FIG. 2A, the example 200 includes a first random selection from the plurality of possible control groups that are represented by open circles. The open circles may be visualized according to a target variable as well as a related variable, as shown in FIG. 2A. Other examples may exclude the related variable or include a plurality of related variables. The example 200 further shows a test group that is represented by a closed circle. The closed circle may also be visualized according to the target variable as well as the related variable, as shown in FIG. 2A. Therefore, k nearest neighbors (represented by open diamonds in FIG. 2A) may be selected from the first random selection using the target variable as well as the related variable. In FIG. 2A, k is five, but other examples may use fewer nearest neighbors (e.g., four, three, and so on) or more nearest neighbors (e.g., six, seven, and so on).

As shown in FIG. 2B, the example 200 further includes a second random selection from the plurality of possible control groups that are represented by open circles. The open circles may be visualized according to the target variable as well as the related variable, as shown in FIG. 2B. The example 200 further shows the test group represented by a closed circle. In FIG. 2B, k nearest neighbors (represented by open diamonds in FIG. 2B) may be selected from the second random selection using the target variable as well as the related variable. In FIG. 2B, k is again five, but other examples may use fewer nearest neighbors (e.g., four, three, and so on) or more nearest neighbors (e.g., six, seven, and so on).

By using techniques as described in connection with FIGS. 2A-2B, control groups are bootstrapped using the target variable as well as the related variable. As a result, a target variable change, determined using the control groups, is more likely to be accurate, which conserves power and processing resources that otherwise would have been wasted on selecting new control groups and re-determining the target variable change.

As indicated above, FIGS. 2A-2B are provided as an example. Other examples may differ from what is described with regard to FIGS. 2A-2B.

FIG. 3 is a diagram of an example 300 associated with a target variable change. The example 300 of FIG. 3 may represent a calculation from a simulator device, which may be output by a user device. These devices are described in more detail in connection with FIGS. 5 and 6.

As shown in FIG. 3, target variable information, across time and associated with a test group, may be represented by a first trend line (shown as solid). As further shown in FIG. 3, target variable information, across time and associated with a control group, may be represented by a second trend line (shown as dashed). Therefore, to determine a target variable change that is associated with a casual event (shown in FIG. 3), a distance between the first and second trend lines may be calculated. The target variable change may be referred to as a “lift,” as shown in FIG. 3. In the example 300, the distance is calculated at a particular time after the causal event. Other examples, however, may include the distance being a median (or an average) of multiple distances calculated at multiple points in time after the causal event.

As indicated above, FIG. 3 is provided as an example. Other examples may differ from what is described with regard to FIG. 3. For example, other examples may include multiple second trend lines (associated with multiple control groups). Therefore, the target variable change may be based on multiple distances calculated between the first trend line and multiple second trend lines.

FIGS. 4A and 4B are diagrams of examples 400 and 450, respectively, associated with control group validation. The examples 400 and 450 may represent operations performed by a simulator device, which is described in more detail in connection with FIGS. 5 and 6.

As shown in FIG. 4A, a distribution of a target variable may be visualized for a test group. As further shown in FIG. 4A, a distribution of the target variable may be visualized for a control group. The distribution may be calculated prior to a causal event. To determine that the control group is similar to the test group prior to the casual event, a difference between the distributions may be calculated. For example, a median (or average) distance between fitted lines on the distributions may be used as a difference. Other examples, however, may include other measurements of distance between the distributions, such as a Z-test or a Kolmogorov-Smirnov test, among other examples. A target variable change experienced by the test group may be validated based on the difference satisfying a validation threshold.

As shown in FIG. 4B, target variable information, across time and associated with a first control group, may be represented by a first trend line (shown as solid). As further shown in FIG. 4B, target variable information, across time and associated with a second control group, may be represented by a second trend line (shown as dashed). Therefore, to determine that the control groups remain similar after a causal event (shown in FIG. 4B), a distance between the first and second trend lines may be calculated. Therefore, a target variable change calculated using the control groups may be validated based on the distance satisfying a validation threshold, when the distance satisfies a validation threshold. In one example, the distance may be calculated at a particular time after the causal event. Other examples, however, may include the distance being a median (or an average) of multiple distances calculated at multiple points in time after the causal event.

By using techniques as described in connection with FIGS. 4A-4B, the target variable change is validated to increase accuracy. As a result, power, processing resources, and network overhead are conserved that otherwise would have been wasted on outputting an inaccurate target variable change.

As indicated above, FIGS. 4A-4B are provided as examples. Other examples may differ from what is described with regard to FIGS. 4A-4B.

FIG. 5 is a diagram of an example environment 500 in which systems and/or methods described herein may be implemented. As shown in FIG. 5, environment 500 may include a simulator device 501, which may include one or more elements of and/or may execute within a cloud computing system 502. The cloud computing system 502 may include one or more elements 503-512, as described in more detail below. As further shown in FIG. 5, environment 500 may include a network 520, a user device 530, a demographic data source 540, and/or a target variable data source 550. Devices and/or elements of environment 500 may interconnect via wired connections and/or wireless connections.

The cloud computing system 502 may include computing hardware 503, a resource management component 504, a host operating system (OS) 505, and/or one or more virtual computing systems 506. The cloud computing system 502 may execute on, for example, an Amazon Web Services platform, a Microsoft Azure platform, or a Snowflake platform. The resource management component 504 may perform virtualization (e.g., abstraction) of computing hardware 503 to create the one or more virtual computing systems 506. Using virtualization, the resource management component 504 enables a single computing device (e.g., a computer or a server) to operate like multiple computing devices, such as by creating multiple isolated virtual computing systems 506 from computing hardware 503 of the single computing device. In this way, computing hardware 503 can operate more efficiently, with lower power consumption, higher reliability, higher availability, higher utilization, greater flexibility, and lower cost than using separate computing devices.

The computing hardware 503 may include hardware and corresponding resources from one or more computing devices. For example, computing hardware 503 may include hardware from a single computing device (e.g., a single server) or from multiple computing devices (e.g., multiple servers), such as multiple computing devices in one or more data centers. As shown, computing hardware 503 may include one or more processors 507, one or more memories 508, and/or one or more networking components 509. Examples of a processor, a memory, and a networking component (e.g., a communication component) are described elsewhere herein.

The resource management component 504 may include a virtualization application (e.g., executing on hardware, such as computing hardware 503) capable of virtualizing computing hardware 503 to start, stop, and/or manage one or more virtual computing systems 506. For example, the resource management component 504 may include a hypervisor (e.g., a bare-metal or Type 1 hypervisor, a hosted or Type 2 hypervisor, or another type of hypervisor) or a virtual machine monitor, such as when the virtual computing systems 506 are virtual machines 510. Additionally, or alternatively, the resource management component 504 may include a container manager, such as when the virtual computing systems 506 are containers 511. In some implementations, the resource management component 504 executes within and/or in coordination with a host operating system 505.

A virtual computing system 506 may include a virtual environment that enables cloud-based execution of operations and/or processes described herein using computing hardware 503. As shown, a virtual computing system 506 may include a virtual machine 510, a container 511, or a hybrid environment 512 that includes a virtual machine and a container, among other examples. A virtual computing system 506 may execute one or more applications using a file system that includes binary files, software libraries, and/or other resources required to execute applications on a guest operating system (e.g., within the virtual computing system 506) or the host operating system 505.

Although the simulator device 501 may include one or more elements 503-512 of the cloud computing system 502, may execute within the cloud computing system 502, and/or may be hosted within the cloud computing system 502, in some implementations, the simulator device 501 may not be cloud-based (e.g., may be implemented outside of a cloud computing system) or may be partially cloud-based. For example, the simulator device 501 may include one or more devices that are not part of the cloud computing system 502, such as device 600 of FIG. 6, which may include a standalone server or another type of computing device. The simulator device 501 may perform one or more operations and/or processes described in more detail elsewhere herein.

The network 520 may include one or more wired and/or wireless networks. For example, the network 520 may include a cellular network, a public land mobile network (PLMN), a local area network (LAN), a wide area network (WAN), a private network, the Internet, and/or a combination of these or other types of networks. The network 520 enables communication among the devices of the environment 500.

The user device 530 may include one or more devices capable of receiving, generating, storing, processing, and/or providing information associated with target variable changes, as described elsewhere herein. The user device 530 may include a communication device and/or a computing device. For example, the user device 530 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 530 may communicate with one or more other devices of environment 500, as described elsewhere herein.

The demographic data source 540 may include one or more devices capable of receiving, generating, storing, processing, and/or providing information associated with census information, as described elsewhere herein. The demographic data source 540 may include a communication device and/or a computing device. For example, the demographic data source 540 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The demographic data source 540 may communicate with one or more other devices of environment 500, as described elsewhere herein.

The target variable data source 550 may include one or more devices capable of receiving, generating, storing, processing, and/or providing information associated with target variable information, as described elsewhere herein. The target variable data source 550 may include a communication device and/or a computing device. For example, the target variable data source 550 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The target variable data source 550 may communicate with one or more other devices of environment 500, as described elsewhere herein.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of the environment 500 may perform one or more functions described as being performed by another set of devices of the environment 500.

FIG. 6 is a diagram of example components of a device 600 associated with control group identification and validation. The device 600 may correspond to a user device 530, a demographic data source 540, and/or a target variable data source 550. In some implementations, a user device 530, a demographic data source 540, and/or a target variable data source 550 may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. In some implementations, the memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

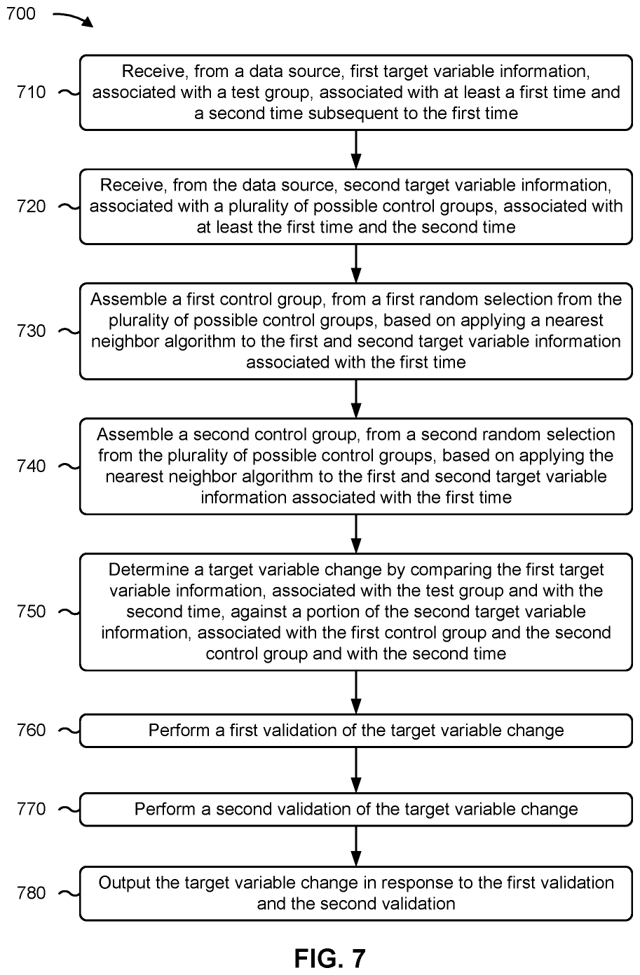

FIG. 7 is a flowchart of an example process 700 associated with control group identification and validation. In some implementations, one or more process blocks of FIG. 7 may be performed by the simulator device 501. In some implementations, one or more process blocks of FIG. 7 may be performed by another device or a group of devices separate from or including the simulator device 501, such as a user device 530, a demographic data source 540, and/or a target variable data source 550. Additionally, or alternatively, one or more process blocks of FIG. 7 may be performed by one or more components of the device 600, such as processor 620, memory 630, input component 640, output component 650, and/or communication component 660.

As further shown in FIG. 7, process 700 may include receiving, from a data source, first target variable information, associated with a test group, associated with at least a first time and a second time subsequent to the first time (block 710). For example, the simulator device 501 (e.g., using processor 620, memory 630, input component 640, and/or communication component 660) may receive, from a data source, first target variable information, associated with a test group, associated with at least a first time and a second time subsequent to the first time, as described above in connection with reference number 125 of FIG. 1B. As an example, the simulator device 501 may transmit (to the data source) a request for target variable information, and the request may include (e.g., in a header and/or as an argument) an indication of the test group. Accordingly, the data source may transmit, to the simulator device 501, the first target variable information in response to the request.

As further shown in FIG. 7, process 700 may include receiving, from the data source, second target variable information, associated with a plurality of possible control groups, associated with at least the first time and the second time (block 720). For example, the simulator device 501 (e.g., using processor 620, memory 630, input component 640, and/or communication component 660) may receive, from the data source, second target variable information, associated with a plurality of possible control groups, associated with at least the first time and the second time, as described above in connection with reference number 125 of FIG. 1B. As an example, the simulator device 501 may transmit (to the data source) a request for target variable information, and the request may include (e.g., in a header and/or as an argument) an indication of the plurality of possible control groups. Accordingly, the data source may transmit, to the simulator device 501, the second target variable information in response to the request.

As further shown in FIG. 7, process 700 may include assembling a first control group, from a first random selection from the plurality of possible control groups, based on applying a nearest neighbor algorithm to the first and second target variable information associated with the first time (block 730). For example, the simulator device 501 (e.g., using processor 620 and/or memory 630) may assemble a first control group, from a first random selection from the plurality of possible control groups, based on applying a nearest neighbor algorithm to the first and second target variable information associated with the first time, as described above in connection with FIG. 1B. As an example, and as described in connection with FIG. 2A, the simulator device 501 may determine the first control group by performing a first random selection, from the plurality of possible control groups, to generate a first random control sample and by selecting the first control group from the first random control sample using the nearest neighbor algorithm.

As further shown in FIG. 7, process 700 may include assembling a second control group, from a second random selection from the plurality of possible control groups, based on applying the nearest neighbor algorithm to the first and second target variable information associated with the first time (block 740). For example, the simulator device 501 (e.g., using processor 620 and/or memory 630) may assemble a second control group, from a second random selection from the plurality of possible control groups, based on applying the nearest neighbor algorithm to the first and second target variable information associated with the first time, as described above in connection with FIG. 1B. As an example, and as described in connection with FIG. 2B, the simulator device 501 may determine the second control group by performing a second random selection, from the plurality of possible control groups, to generate a second random control sample and by selecting the second control group from the second random control sample using the nearest neighbor algorithm.

As further shown in FIG. 7, process 700 may include determining a target variable change by comparing the first target variable information, associated with the test group and with the second time, against a portion of the second target variable information, associated with the first control group and the second control group and with the second time (block 750). For example, the simulator device 501 (e.g., using processor 620 and/or memory 630) may determine a target variable change by comparing the first target variable information, associated with the test group and with the second time, against a portion of the second target variable information, associated with the first control group and the second control group and with the second time, as described above in connection with reference number 130 of FIG. 1C. As an example, the simulator device 501 may calculate a distance between a first trend line associated with the test group and a second trend line associated with the first control group or the second control group, as described in connection with FIG. 3. Therefore, the simulator device may determine the target variable change as a difference, in a target variable, between the test group and the first and second control groups after a causal event.

As further shown in FIG. 7, process 700 may include performing a first validation of the target variable change (block 760). For example, the simulator device 501 (e.g., using processor 620 and/or memory 630) may perform a first validation of the target variable change, as described above in connection with reference number 135 of FIG. 1C. As an example, the simulator device 501 may compare a distribution of the first target variable information, associated with the test group, against a distribution of a portion of the second target variable information, associated with the first control group and the second control group (e.g., as described in connection with FIG. 4A). Therefore, the simulator device 501 may determine a difference measurement, between the distributions, before the causal event and may validate the target variable change based on the difference measurement satisfying a validation threshold.

As further shown in FIG. 7, process 700 may include performing a second validation of the target variable change (block 770). For example, the simulator device 501 (e.g., using processor 620 and/or memory 630) may perform a second validation of the target variable change, as described above in connection with reference number 135 of FIG. 1C. As an example, the simulator device 501 may compare a portion of the second target variable information, associated with the first control group, against a portion of the second target variable information, associated with the second control group. Therefore, the simulator device 501 may determine a distance between a first trend line associated with the first control group and a second trend line associated with the second control group (e.g., as described in connection with FIG. 4B) and may validate the target variable change based on the distance satisfying a validation threshold.

As further shown in FIG. 7, process 700 may include outputting the target variable change in response to the first validation and the second validation (block 780). For example, the simulator device 501 (e.g., using processor 620, memory 630, and/or output component 650) may output the target variable change in response to the first validation and the second validation, as described above in connection with reference number 140a and/or reference number 140b of FIG. 1C. As an example, the simulator device 501 may transmit the target variable change to a user device (e.g., by outputting a table that includes the target variable change). Additionally, or alternatively, the simulator device may output (e.g., to the user device), instructions to display a UI including a first trend line associated with the test group and a second trend line associated with the first control group or the second control group (e.g., an example of which is shown in FIG. 3).

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. The process 700 is an example of one process that may be performed by one or more devices described herein. These one or more devices may perform one or more other processes based on operations described herein, such as the operations described in connection with FIGS. 1A-1C, 2A-2B, 3, and/or 4A-4B. Moreover, while the process 700 has been described in relation to the devices and components of the preceding figures, the process 700 can be performed using alternative, additional, or fewer devices and/or components. Thus, the process 700 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for identifying and validating control groups, the system comprising:
one or more memories; and
one or more processors, communicatively coupled to the one or more memories, configured to:
identify a plurality of possible control groups that are similar to a test group;
receive, from a data source, first target variable information, associated with the test group, associated with at least a first time and a second time subsequent to the first time;
receive, from the data source, second target variable information, associated with the plurality of possible control groups, associated with at least the first time and the second time;
assemble a first control group, from a first random selection from the plurality of possible control groups, based on applying a nearest neighbor algorithm to the first and second target variable information associated with the first time;
assemble a second control group, from a second random selection from the plurality of possible control groups, based on applying the nearest neighbor algorithm to the first and second target variable information associated with the first time;
determine a target variable change by comparing the first target variable information, associated with the test group and with the second time, against a portion of the second target variable information, associated with the first control group and the second control group and with the second time;
perform a first validation of the target variable change by comparing a distribution of the first target variable information, associated with the test group and with the first time, against a distribution of a portion of the second target variable information, associated with the first control group and the second control group and with the first time;
perform a second validation of the target variable change by comparing a portion of the second target variable information, associated with the first control group and with the second time, against a portion of the second target variable information, associated with the second control group and with the second time; and
output the target variable change in response to the first validation and the second validation.

2. The system of claim 1, wherein the one or more processors are configured to:
receive, from an additional data source, first census information, associated with the test group; and
receive, from the additional data source, second census information, associated with the plurality of possible control groups,
wherein the plurality of possible control groups are identified using the first census information and the second census information.

3. The system of claim 1, wherein the one or more processors, to identify the plurality of possible control groups, are configured to:
determine that a difference, between first census information associated with the test group and second census information associated with the plurality of possible control groups, satisfies a similarity threshold.

4. The system of claim 1, wherein the one or more processors are configured to:
performing standardization on the first and second target variable information; and
performing winsorizing on the second target variable information.

5. The system of claim 1, wherein the test group is associated with a census block group, and the plurality of possible control groups are associated with a plurality of additional census block groups.

6. The system of claim 1, wherein the one or more processors, to determine the target variable change, are configured to:
calculate a distance between a first trend line associated with the test group and a second trend line associated with the first control group or the second control group.

7. The system of claim 1, wherein the one or more processors, to output the target variable change, are configured to:
output a table including the target variable change.

8. The system of claim 1, wherein the one or more processors, to output the target variable change, are configured to:
output instructions to display a user interface including a first trend line associated with the test group and a second trend line associated with the first control group or the second control group.

9. A method of identifying and validating control groups, comprising:
receiving, from a data source, first target variable information, associated with a test group, associated with at least a first time and a second time subsequent to the first time;
receiving, from the data source, second target variable information, associated with a plurality of possible control groups, associated with at least the first time and the second time;
determining, by a simulator device, a first control group, from a first random selection from the plurality of possible control groups, based on applying a nearest neighbor algorithm to the first and second target variable information associated with the first time;
determining, by the simulator device, a second control group, from a second random selection from the plurality of possible control groups, based on applying the nearest neighbor algorithm to the first and second target variable information associated with the first time;
determining, by the simulator device, a target variable change based on the first target variable information, associated with the test group and with the second time, and a portion of the second target variable information, associated with the first control group and the second control group and with the second time;
validating, by the simulator device, the target variable change based on a portion of the second target variable information, associated with the first control group and with the second time, and a portion of the second target variable information, associated with the second control group and with the second time; and
outputting, to a user device, the target variable change in response to validating the target variable change.

10. The method of claim 9, further comprising:
receiving, at the simulator device, an indication of the test group and an indication of the plurality of possible control groups.

11. The method of claim 9, wherein determining the first control group comprises:
performing the first random selection, from the plurality of possible control groups, to generate a first random control sample; and
selecting the first control group from the first random control sample using the nearest neighbor algorithm.

12. The method of claim 11, wherein determining the first control group comprises:
performing the second random selection, from the plurality of possible control groups, to generate a second random control sample; and
selecting the second control group from the second random control sample using the nearest neighbor algorithm.

13. The method of claim 9, wherein the test group is associated with a geographic area, and the plurality of possible control groups are associated with a plurality of additional geographic areas.

14. The method of claim 9, wherein validating the target variable change comprises:
determining that a distance, between a first trend line associated with the first control group and a second trend line associated with the second control group, satisfies a validation threshold.

15. A non-transitory computer-readable medium storing a set of instructions for identifying and validating control groups, the set of instructions comprising:
one or more instructions that, when executed by one or more processors of a device, cause the device to:
receive, from a data source, first target variable information, associated with a test group, associated with at least a first time and a second time subsequent to the first time;
receive, from the data source, second target variable information, associated with a plurality of possible control groups, associated with at least the first time and the second time;
identify a first control group, from a first random selection from the plurality of possible control groups, based on applying a nearest neighbor algorithm to the first and second target variable information associated with the first time;
identify a second control group, from a second random selection from the plurality of possible control groups, based on applying the nearest neighbor algorithm to the first and second target variable information associated with the first time;
determine a target variable change using the first target variable information, associated with the test group and with the second time, and a portion of the second target variable information, associated with the first control group and the second control group and with the second time;
perform a validation of the target variable change using a distribution of the first target variable information, associated with the test group and with the first time, and a distribution of a portion of the second target variable information, associated with the first control group and the second control group and with the first time; and
output the target variable change in response to the validation.

16. The non-transitory computer-readable medium of claim 15, wherein the one or more instructions, that cause the device to output the target variable change, cause the device to:
output instructions to display a user interface including a first trend line associated with the test group and a second trend line associated with the first control group or the second control group.

17. The non-transitory computer-readable medium of claim 15, wherein the one or more instructions, that cause the device to output the target variable change, cause the device to:
output a table including the target variable change.

18. The non-transitory computer-readable medium of claim 15, wherein the one or more instructions, that cause the device to perform the validation of the target variable change, cause the device to:
determine that a difference measurement, between the distribution of the first target variable information and the distribution of the portion of the second target variable information, satisfies a validation threshold.

19. The non-transitory computer-readable medium of claim 15, wherein the test group is associated with a census block group, and the plurality of possible control groups are associated with a plurality of additional census block groups.

20. The non-transitory computer-readable medium of claim 15, wherein the test group is associated with a geographic area, and the plurality of possible control groups are associated with a plurality of additional geographic areas.
